(19) United States
(12) Patent Application Publication
(10) Pub. No.: US 2022/0363831 A1
(43) Pub. Date: Nov. 17, 2022

(54) Polyamideimide Film and Image Display Device Comprising the Same

(71) Applicants: SK Innovation Co., Ltd., Seoul (KR); SK ie technology Co., Ltd., Seoul (KR)

(72) Inventors: Seung Min Jeon, Daejeon (KR); Jin Hyung Park, Daejeon (KR); Hye Ri Kim, Daejeon (KR); Cheol Min Yun, Daejeon (KR)

(21) Appl. No.: 17/742,898

(22) Filed: May 12, 2022

(30) Foreign Application Priority Data
May 13, 2021 (KR) 10-2021-0061731

(51) Int. Cl. C08G 73/14; C08K 3/36

(52) U.S. Cl. CPC C08G 73/14; C08K 3/36

(57) ABSTRACT

Provided is a polyamideimide film and an image display device including the same and a polyamideimide film which may satisfy a high light transmittance while maintaining mechanical properties to significantly improve viewing properties, and may satisfy all of a low refractive index, a low retardation in the unit thickness direction (Rₜₕ), a low yellow index, a low haze, and the like to significantly improve optical properties such as transparency and visibility. An image display device including the same is also provided.

### CROSS-REFERENCE TO RELATED APPLICATION

This application claims priority to Korean Patent Application No. 10-2021-0061731 filed May 13, 2021, the disclosure of which is hereby incorporated by reference in its entirety.

### BACKGROUND OF THE INVENTION

### Field of the Invention

The following disclosure relates to a polyamideimide film and an image display device including the same.

### Description of Related Art

In general, since polyimide has excellent mechanical and thermal properties, it is applied to various fields including an insulating substrate field for forming circuits and devices. However, a charge transfer complex is formed between aromatic rings at the time of polymerization so that polyimide is colored brown or yellow, which leads a low transmittance in the visible light region, and thus, it is difficult to apply polyimide to display materials.

As a method of making the polyimide colorless and transparent, a method of using an alicyclic diamine or an aliphatic diamine as a diamine component to suppress formation of an intramolecular charge transfer composite is known in the art. Japanese Patent Laid-Open Publication No. 2002-161136 discloses a polyimide obtained by imidizing a polyimide precursor formed by aromatic acid dianhydride such as pyromellitic acid dianhydride and trans-1,4-diaminocyclohexane, which shows high transparency but has deteriorated mechanical properties.

In addition, as a method for converting yellow polyimide into colorless and transparent polyimide, it is attempted to use various functional monomers, but the approach is difficult due to the problems in the manufacturing process such as rapidly increased viscosity during polymerization or difficulty in purification, and the method secures transparency, but is insufficient to solve the problem of deterioration of intrinsic excellent mechanical properties of polyimide.

Meanwhile, in display material, a study to replace a cover glass for display with a polymer material is being conducted, and polyimide is attracting attention as a material for replacing a cover glass.

Thus, development of technology for polyimide which satisfies all of a high light transmittance, a low retardation in the thickness direction (Rₜₕ), a low yellow index, a low haze value, and the like by a low refractive index to have excellent optical properties while intrinsic excellent mechanical properties are not deteriorated, so that it may be applied to display material fields including a cover glass replacement material, thereby further widening the application range, is demanded.

### SUMMARY OF THE INVENTION

An embodiment is directed to providing a polyamideimide film which may show a high light transmittance throughout a visible light region, and also satisfy all physical properties of a low refractive index, a low retardation in the thickness direction (Rₜₕ), a low yellow index, and a low haze value to implement excellent optical properties and implement excellent mechanical strength including a high modulus, and an image display device including the same.

Another embodiment is directed to providing a polyamideimide film which may satisfy a total light transmittance of 90% or more as measured at 400 to 700 nm in accordance with the ASTM D1003 specification to significantly improve viewing properties when being applied to a window cover film.

Another embodiment is directed to providing a polyamideimide film which satisfies a refractive index of less than 1.63 to significantly improve transparency.

Still another embodiment is directed to providing a polyamideimide film which satisfies all physical properties of a retardation in the thickness direction (Rₜₕ) of 3,500 nm or less at a thickness of 50 μm, a haze of 1.5% or less, and a yellow index of 2.5 or less as measured in accordance with the ASTM E313 specification to significantly improve optical properties such as visibility.

In one general aspect, a polyamideimide film includes: a polyamideimide resin derived from an aromatic diamine, an acid anhydride, and an aromatic diacid dichloride and inorganic nanoparticles, wherein a content of the inorganic nanoparticles is 20 to 65 wt % of the polyamideimide film, and a total light transmittance is 90% or more as measured at 400 to 700 nm in accordance with the ASTM D1003 specification.

In an implementation, the inorganic nanoparticles may have an average diameter of 50 nm or less, and more specifically 5 to 20 nm.

In an implementation, a content of the inorganic nanoparticles may be 20 to 50 wt % of the polyamideimide film.

In an implementation, the inorganic nanoparticles may be any one or a mixture of two or more selected from silica, zirconium oxide, titanium oxide, zinc oxide, zinc sulfide, chromium oxide, and barium titanate.

In an implementation, the inorganic nanoparticle may be surface-treated for improving dispersibility in an organic solvent.

In an implementation, the aromatic diamine may be any one or a mixture of two or more selected from N,N′-[2,2′-bis(trifluoromethyl)-[1,1′-biphenyl]-4,4′-diyl] bis[4-aminobenzamide] (AB-TFMB), 2,2′-bis(trifluoromethyl)-benzidine (TFMB), 4,4′-diaminobenzanilide (DABA), 1,4-bis(4-amino-2-trifluoromethylphenoxy)benzene (6FAPB), and 2,2′-bis(trifluoromethyl)-4,4′-diaminodiphenylether (6FODA).

In an implementation, the aromatic diacid dichloride may be any one or a mixture of two or more selected from terephthaloyl dichloride, isophthaloyl dichloride, 1,1′-biphenyl-4,4′-dicarbonyl dichloride, 1,4-naphthalene dicarboxylic dichloride, 2,6-naphthalene dicarboxylic dichloride, and 1,5-naphthalene dicarboxylic dichloride.

In an implementation, a content of the aromatic diacid dichloride may be more than 50 mol % with respect to both of the acid anhydride and the aromatic diacid dichloride.

In an implementation, the acid anhydride may include an aromatic dianhydride and a cycloaliphatic dianhydride.

In an implementation, the aromatic dianhydride may be 4,4′-hexafluoroisopropylidene diphthalic anhydride, and the cycloaliphatic dianhydride may be cyclobutanetetracarboxylic dianhydride.

In an implementation, the cycloaliphatic dianhydride may be any one or a mixture of two or more selected from 1,2,3,4-cyclobutanetetracarboxylic dianhydride (CBDA), 5-(2,5-dioxotetrahydrofuryl)-3-methylcyclohexene-1,2-dicarboxylic dianhydride (DOCDA), bicyclooxtene-2,3,5,6-tetracarboxylic dianhydride (BODA), 1,2,3,4-cyclopentanetetracarboxylic dianhydride (CPDA), 1,2,4,5-cyclohexanetetracarboxylic dianhydride (CHDA), 1,2,4-tricarboxy-3-methylcarboxycyclopentane dianhydride, and 1,2,3,4-tetracarboxycyclopentane dianhydride.

In an implementation, the polyamideimide film may have a refractive index of less than 1.63 and a retardation in the thickness direction (Rₜₕ) of 3,500 nm or less at a thickness of 50 μm.

In an implementation, the polyamideimide film may have a haze of 1.5% or less and a yellow index of 2.5 or less as measured in accordance with the ASTM E313 specification.

In an implementation, the polyamideimide film may have a haze of 0.7% or less.

In an implementation, the polyamideimide film may have a modulus of 5.0 GPa or more as measured at an extension speed of 50 mm/min using Instron UTM 3365.

In another general aspect, an image display device includes the polyamideimide film described above.

An implementation relates to a polyamideimide film and an image display device including the same, and the polyamideimide film shows a high light transmittance throughout a visible light region, and also satisfies all physical properties of a low refractive index, a low retardation in the thickness direction (Rₜₕ), a low yellow index, and a low haze value to implement excellent optical properties and implement excellent mechanical strength including a high modulus.

In addition, the polyamideimide film according to an embodiment satisfies a total light transmittance of 90% or more as measured at 400 to 700 nm in accordance with the ASTM D1003 specification to significantly improve viewing properties when being applied to a window cover film.

In addition, the polyamideimide film according to an embodiment satisfies a low refractive index of less than 1.63 to significantly improve transparency.

In addition, the polyamideimide film according to an embodiment satisfies all physical properties of a retardation in the thickness direction (Rₜₕ) of 3,500 nm or less at a thickness of 50 μm, a haze of 1.5% or less, and a yellow index of 2.5 or less as measured in accordance with the ASTM E313 specification to significantly improve optical properties such as visibility.

### DESCRIPTION OF THE INVENTION

Hereinafter, a polyamideimide film according to an implementation and an image display device including the same will be described in detail.

Herein, unless otherwise defined, all technical terms and scientific terms have the same meanings as those commonly understood by one of those skilled in the art to which the present disclosure pertains. The terms used in the description of the present specification are only for effectively describing certain specific examples, and are not intended to limit the implementation. Further, unless otherwise stated, the unit of added materials which is not particularly described in the specification may be wt %.

In addition, the singular form used in the specification and claims appended thereto may be intended to also include a plural form, unless otherwise indicated in the context.

Throughout the present specification, unless explicitly described to the contrary, “comprising” any constituent elements will be understood to imply further inclusion of other constituent elements rather than the exclusion of any other constituent elements.

Hereinafter, unless otherwise defined in the present specification, a “combination thereof” refers to a mixture or copolymerization of constituents.

Hereinafter, unless otherwise particularly defined in the present specification, the term “derived” means a form in which at least any one of the functional groups of a compound is modified, and specifically a reacting group and/or a leaving group of a compound is/are modified or left by the reaction. In addition, when structures derived from different compounds are the same, a structure derived from any one compound may also include a case of being derived from any other compound to have the same structure.

Hereinafter, unless otherwise particularly defined in the present specification, a “polymer” refers to a molecule which has a relatively high molecular weight and the structure may include multiple repetition of a unit derived from a low molecular weight molecule. In an embodiment, the polymer may be an alternating copolymer, a block copolymer, a random copolymer, a branched copolymer, a crosslinked copolymer, or a copolymer including all of them (for example, a copolymer including more than one monomer). In another embodiment, the polymer may be a homopolymer (for example, a copolymer including one monomer).

Hereinafter, unless otherwise particularly defined in the present specification, “polyimide” includes an imide structure, and may be used in the meaning of including “polyimide” or “polyamideimide”.

Conventional polyimide has a charge transfer complex (CTC) structure as polymer chain packing occurs, thereby lowering a transmittance in a visible light region.

The present inventors found that, surprisingly, a polyamideimide film including a polyamideimide resin derived from a combination of an aromatic diamine, an acid anhydride, and an aromatic diacid dichloride, and a certain content of inorganic nanoparticles shows a high light transmittance throughout a visible light region, and also satisfies all physical properties of a low refractive index, a low retardation in the thickness direction (Rₜₕ), a low yellow index, and a low haze value to implement excellent optical properties, while maintaining excellent mechanical strength including a high modulus, thereby completing the present disclosure.

Specifically, an embodiment may provide a polyamideimide film including a polyamideimide resin derived from a combination of an aromatic diamine, an acid anhydride, and an aromatic diacid dichloride and inorganic nanoparticles, in order to provide a polyamideimide film which significantly improves optical properties while maintaining excellent mechanical, thermal, and electrical properties to be applied to various fields including a display.

The polyamideimide film according to an implementation will be described in more detail, as follows.

The polyamideimide film according to an embodiment includes a polyamideimide resin derived from an aromatic diamine, an acid anhydride, and an aromatic diacid dichloride and inorganic nanoparticles, wherein a content of the inorganic nanoparticles is 20 to 65 wt % of the polyamideimide film, and the polyamideimide film may have a total light transmittance of 90% or more as measured at 400 to 700 nm in accordance with the ASTM D1003 specification.

The polyamideimide film satisfying the composition shows a high light transmittance throughout a visible light region, and also satisfy all physical properties of a low refractive index, a low retardation in the thickness direction (Rₜₕ), a low yellow index, and a low haze value to implement excellent optical properties, while maintaining excellent mechanical strength including a high modulus.

More specifically, in the polyamideimide film according to an embodiment, a content of the inorganic nanoparticles may be 20 to 50 wt %, more specifically 20 to 45 wt % of the polyamideimide film, but is not necessarily limited thereto as long as the object of the present disclosure is achieved.

When the content of the inorganic nanoparticles is less than 20 wt % of the polyamideimide film, a total light transmittance measured at 400 to 700 nm in accordance with the ASTM D1003 specification of the polyamideimide film is lowered and a high value of a retardation in the thickness direction (Rₜₕ) of more than 3,500 nm at a thickness of 50 μm is shown, and thus, viewing properties are not good, and a rainbow phenomenon, reflection mura, and the like are easily observed, so that a phenomenon of visibility being lowered may occur and optical properties such as a yellow index are also greatly deteriorated. In addition, when the content of the inorganic nanoparticles is more than 65 wt % of the polyamideimide film, the optical properties such as a yellow index and haze of the polyamideimide film are significantly deteriorated so that it is difficult to secure sufficient transparency, and even the film itself may not be formed.

In the polyamideimide film according to an embodiment, the inorganic nanoparticles may include any one or a combination thereof selected from spherical inorganic nanoparticles and angled amorphous inorganic nanoparticles. Specifically, the inorganic nanoparticles may include only spherical inorganic nanoparticles, but is not necessarily limited thereto. Here, the “spherical” shape includes not only a full spherical shape of which the surface is substantially at an equal distance from the center but also a round shape close to a spherical shape with no angle formed, and also, the “angled amorphous shape” is not particularly limited as long as the particles are angled, and for example, the shape may be selected from a polyhedral shape selected from amorphous, rod, tetrahedral, hexahedral, and octahedral shapes, and the like, a plate shape, and the like.

In addition, in the polyamideimide film according to an embodiment, the inorganic nanoparticles are nano-sized particles and may have an average diameter of 50 nm or less, and for example, of 30 nm or less, for example, 20 nm or less, but the present disclosure is not necessarily limited thereto as long as the object of the present disclosure is achieved. More specifically, the inorganic nanoparticles may have a size of an average diameter of 5 to 50 nm, more specifically 5 to 30 nm, and still more specifically 5 to 20 nm, but the present disclosure is not necessarily limited thereto as long as the object of the present disclosure is achieved.

When the average diameter of the inorganic nanoparticles is more than 50 nm, the polyamideimide film including the particles has a significantly lowered light transmittance and significantly deteriorated optical properties such as a yellow index and haze, so that it is difficult to sufficiently secure the transparency of the film. Therefore, when the size of the inorganic nanoparticles satisfies the range, the optical properties and the mechanical properties of the polyamideimide film including the particles may be further improved, which is thus preferred.

Here, the meaning of the average diameter is an average particle diameter when the inorganic nanoparticles are spherical inorganic nanoparticles, and is a longest length when the inorganic nanoparticles are angled inorganic nanoparticles, and the average particle diameter of the spherical inorganic nanoparticles refers to D50 which is a particle diameter at which a total volume corresponds to 50% when particle diameters of the inorganic nanoparticles are measured respectively, and the volume is accumulated from a smallest particle, and the longest length of the angled amorphous inorganic nanoparticles refers to D50 which is a size at which a total volume corresponds to 50% when sizes of the inorganic nanoparticles are measured respectively, and the volume is accumulated from a smallest particle.

When the polyamideimide film according to an embodiment is formed, a bridge between the polyamideimide resin and the inorganic nanoparticle is derived by means such as heating to form a crosslink, and the crosslink may be crosslinking of all or part of the inorganic nanoparticles, but the present disclosure is not necessarily limited thereto.

Here, when the content of the inorganic nanoparticles satisfies 20 to 65 wt % of the polyamideimide film, the crosslink may be formed better, and within the range of not deteriorating the mechanical, thermal, and electrical properties of the film, the visibility, the transparency, and the like of the film may be improved by the crosslink to implement excellent optical properties at the same time. In particular, when the inorganic nanoparticles have an average diameter of 50 nm or less, the effect by the crosslink may be highly implemented, which is thus preferred.

In addition, in the polyamideimide film according to an embodiment, the maximum and minimum values of the inorganic nanoparticles may be a value corresponding to 20%, specifically 10%, and more specifically 5% of the average diameter, but are not necessarily limited thereto.

As an example, when the average diameter of the inorganic nanoparticles is 50 nm, and the maximum and minimum values of the diameter are ±20% of the average diameter, each diameter of the inorganic nanoparticles may satisfy 40 to 60 nm, and when the average diameter of 10 nm and the maximum and minimum values of the diameter is ±10% of the average diameter, each diameter of the inorganic nanoparticles may satisfy 9 to 11 nm, but this is a non-limiting example, and the present disclosure is not necessarily limited thereto.

More specifically, the polyamideimide film according to an embodiment may have very surprising effects of satisfying a total light transmittance of 90% or more as measured at 400 to 700 nm in accordance with the ASTM D1003 specification to express significantly improved viewing properties when the film is applied to a window cover film, allowing control of a refractive index so that a low refractive index of less than 1.63 is satisfied, to significantly improve transparency, and satisfying all physical properties of a retardation in the thickness direction (Rₜₕ) of 3,500 nm or less at a thickness of 50 μm, a haze of 1.5% or less as measured in accordance with the ASTM D1003 specification, and a yellow index of 2.5 or less as measured in accordance with the ASTM E313 specification to have significantly improved optical properties, while maintaining excellent mechanical, thermal, and electrical properties.

In the polyamideimide film according to an embodiment, the inorganic nanoparticles may be any one or a mixture of two or more selected from silica, zirconium oxide, titanium oxide, zinc oxide, zinc sulfide, chromium oxide, and barium titanate. Specifically, the inorganic nanoparticles may be silica, but is not necessarily limited thereto.

In the polyamideimide film according to an embodiment, the inorganic nanoparticles may be mixed with the polyamideimide resin in the form of being dispersed in an organic solvent, or may be a surface-treated material for improving the dispersity. When the inorganic nanoparticles in the form of a solid which is not dispersed in an organic solvent are mixed with the polyamideimide resin, it is difficult to uniformly disperse the inorganic nanoparticles in the polyamideimide film produced therefrom, and thus, it may be somewhat difficult to implement optical properties and mechanical properties to be derived in the present disclosure.

Here, the type of organic solvent is not largely limited, and as an example, may be any one or a mixture of two or more selected from dimethylacetamide (DMAc), N-methyl-2-pyrrolidone (NMP), dimethylformamide (DMF), dimethylsulfoxide (DMSO), acetone, ethyl acetate, m-cresol, and the like. Specifically, the organic solvent may be dimethylacetamide (DMAc), but is not necessarily limited thereto.

In the polyamideimide film according to an embodiment, the aromatic diamine may be an aromatic diamine to which a fluorine substituent is introduced or which includes an amide structure, and for example, may be any one or a mixture of two or more selected from N,N′-[2,2′-bis(trifluoromethyl)-[1,1′-biphenyl]-4,4′-diyl] bis[4-aminobenzamide] (AB-TFMB), 2,2′-bis(trifluoromethyl)-benzidine (TFMB), 4,4′-diaminobenzanilide (DABA), 1,4-bis(4-amino-2-trifluoromethylphenoxy)benzene (6FAPB), and 2,2′-bis(trifluoromethyl)-4,4′-diaminodiphenylether (6FODA), and more specifically, may be 2,2′-bis(trifluoromethyl)-benzidine (TFMB), but is not necessarily limited thereto as long as the object of the present disclosure is achieved. Thus, better optical properties may be imparted by a charge transfer effect of fluorine substituents, and better mechanical properties may be more highly implemented by a hydrogen bond of the amide structure.

In the polyamideimide film according to an embodiment, the aromatic diacid dichloride forms an amide structure in a polymer chain, and may improve mechanical properties including a modulus in a range of not deteriorating optical properties.

In the polyamideimide film according to an embodiment, the aromatic diacid dichloride may be any one or a mixture of two or more selected from terephthaloyl dichloride (TPC), isophthaloyl dichloride (IPC), [1,1′-biphenyl]-4,4′-dicarbonyl dichloride (BPC), 1,4-naphthalene dicarboxylic dichloride, 2,6-naphthalene dicarboxylic dichloride, and 1,5-naphthalene dicarboxylic dichloride, and for example, when the mixture of two or more is used, terephthaloyl dichloride may be included, and more specifically, terephthaloyl dichloride may be used alone, but the present disclosure is not necessarily limited thereto.

In the polyamideimide film according to an embodiment, the aromatic diacid dichloride may be included at more than 50 mol %, specifically at more than 50 mol % and 90 mol % or less, for example, 60 to 90 mol %, and for example, 60 to 80 mol % with respect to both of the acid anhydride and the aromatic diacid dichloride, but is not necessarily limited as long as the object of the present disclosure is achieved.

In the polyamideimide film according to an embodiment, the acid anhydride may include an aromatic dianhydride and a cycloaliphatic dianhydride.

In the polyamideimide film according to an embodiment, the aromatic dianhydride is not largely limited, but as an example, may be any one or a mixture of two or more selected from 4,4′-hexafluoroisopropylidene diphthalic anhydride (6FDA), 1,2,4,5-benzene tetracarboxylic dianhydride (PMDA), biphenyl tetracarboxylic dianhydride (BPDA), benzophenone tetracarboxylic dianhydride (BTDA), 4,4′-oxydiphthalic dianhydride (ODPA), and bisdicarboxyphenoxydiphenyl sulfide dianhydride (BDSDA), and specifically, for example, 4,4′-hexafluoroisopropylidene diphthalic anhydride (6FDA) may be used alone, but the present disclosure is not necessarily limited thereto as long as the object of the present disclosure is achieved.

In addition, the content of the aromatic dianhydride is not limited as long as the object of the present disclosure is achieved, but as an example, 40 mol % or less, more specifically 10 to 40 mol %, or 10 to 30 mol % of the aromatic dianhydride may be copolymerized with respect to 100 mol of the aromatic diamine, but the present disclosure is not necessarily limited thereto.

In the polyamideimide film according to an embodiment, the cycloaliphatic dianhydride is used separately from the aromatic dianhydride, and though the type is not particularly limited as long as the object of the present disclosure is achieved, the cycloaliphatic dianhydride may be, as an example, any one or a mixture of two or more selected from 1,2,3,4-cyclobutanetetracarboxylic dianhydride (CBDA), 5-(2,5-dioxotetrahydrofuryl)-3-methylcyclohexene-1,2-dicarboxylic dianhydride (DOCDA), bicyclooctene-2,3,5,6-tetracarboxylic dianhydride (BODA), 1,2,3,4-cyclopentanetetracarboxylic dianhydride (CPDA), 1,2,4,5-cyclohexanetetracarboxylic dianhydride (CHDA), 1,2,4-tricarboxy-3-methylcarboxycyclopentane dianhydride, and 1,2,3,4-tetracarboxycyclopentane dianhydride, and as a more specific example, cyclobutanetetracarboxylic dianhydride may be used alone, but the present disclosure is not necessarily limited thereto as long as the object of the present disclosure is achieved.

In addition, the content of the cycloaliphatic dianhydride is not limited as long as the object of the present disclosure is achieved, but as an example, 40 mol % or less, more specifically 5 to 40 mol %, or 5 to 30 mol % of the cycloaliphatic dianhydride may be copolymerized with respect to 100 mol of the aromatic diamine, but the present disclosure is not necessarily limited thereto.

The polyamideimide film including the polyamideimide resin derived from the aromatic diamine, the acid anhydride, and the aromatic diacid dichloride, having the properties described above, and the inorganic nanoparticle having a certain content have a further improved total light transmittance measured at 400 to 700 nm in accordance with the ASTM D1003 specification, and thus, may have further improved viewing properties. In addition, the refractive index may be further lowered to further significantly improve the transparency of the film, the properties satisfying all of a retardation in the thickness direction (Rₜₕ) of 3,500 nm or less at the thickness of 50 μm, a haze of 1.5% or less as measured in accordance with the ASTM D1003 specification, and a yellow index of 2.5 or less as measured in accordance with the ASTM E313 specification may be better implemented, optical properties may be further significantly improved, and the modulus is further improved, so that mechanical properties are excellent.

In the polyamideimide film according to an embodiment, the polyamideimide film satisfies a total light transmittance of 90% or more as measured at 400 to 700 nm in accordance with the ASTM D1003 specification to have significantly improved viewing properties, allows control of a refractive index so that a low refractive index of less than 1.63 is satisfied to significantly improve transparency, and may satisfy all physical properties of a retardation in the thickness direction (Rₜₕ) of 3,500 nm or less at a thickness of 50 μm, a haze of 1.5% or less as measured in accordance with the ASTM D1003 specification, and a yellow index of 2.5 or less as measured in accordance with the ASTM E313 specification.

More specifically, in the polyamideimide film according to an embodiment, the polyamideimide film may have a total light transmittance of 90% or more, more specifically 91% or more, and still more specifically 92% or more as measured at 400 to 700 nm in accordance with the ASTM D1003 specification, but the present disclosure is not necessarily limited thereto. By satisfying a high light transmittance in the above range, the polyamideimide film according to an embodiment has significantly improved viewing properties, and when being applied to a window cover film, may express further improved viewing properties.

In the polyamideimide film according to an embodiment, the polyamideimide film may have a refractive index of less than 1.63, for example, 1.60 or less. More specifically, the refractive index may be 1.50 to 1.60, but is not necessarily limited thereto. The refractive index may be a value measured at a wavelength of about 543 nm at a temperature of about 23° C. By satisfying a low refractive index in the above range, the polyamideimide film according to an embodiment has significantly improved transparency, and thus, has a high value for use in various fields including a display.

In addition, in the polyamideimide film according to an embodiment, the polyamideimide film may have a retardation in the thickness direction (Rₜₕ) of 3500 nm or less, specifically 2000 to 3500 nm at a thickness of 50 μm of the polyamideimide film, but the present disclosure is not necessarily limited thereto. By having the retardation in the above range, the polyamideimide film according to an embodiment has significantly excellent visibility and appearance quality, and thus, may provide optical properties which are very appropriate for use in various fields including a display.

Herein, the retardation in the thickness direction (Rₜₕ) refers to a value of the retardation in the thickness direction at a wavelength of 550 nm, derived by the following Calculation Formula 1:

$${R}_{th} = [ \frac{nx + ny}{2} - nz ] * d \qquad [ Calculation Formula 1 ]$$

wherein nx is a refractive index in the x direction, ny is a refractive index in the y direction, nz is a refractive index in the z direction, and d is a thickness (μm) of the polyamideimide film.

In the polyamideimide film according to an embodiment, the polyamideimide film may have a yellow index of 2.5 or less or 2.0 or less, a haze of 1.5% or less or 1.0% or less, but the present disclosure is not necessarily limited thereto.

Therefore, the polyamideimide film according to an embodiment may satisfy an excellent light transmittance and a low retardation in the thickness direction (Rₜₕ) as mentioned above, and may implement significantly low yellow index and haze values which are significantly lower than those of a conventional polyamideimide film, and thus, has surprisingly improved optical properties.

In addition, in the polyamideimide film according to an embodiment, the polyamideimide film may have a modulus of 5.0 GPa or more, 6.0 GPa or more, 5.0 to 10.0 GPa, or 6.0 to 10.0 GPa as measured at an extension speed of 50 mm/min using Instron UTM 3365, but the present disclosure is not necessarily limited thereto as long as the object of the present disclosure is achieved. By satisfying the modulus properties in the above range, the polyamideimide film according to an embodiment satisfies all of excellent mechanical, thermal, and electrical properties, in that it may have significantly improved optical properties and also have mechanical properties which are not deteriorated at all as compared with the conventional polyimide-based film, and thus, has a further higher value for use.

Another embodiment provides an image display device including the polyamideimide film.

Here, the image display device is not particularly limited as long as it belongs to fields requiring excellent optical properties, and specifically, for example, may be any one or more selected from a liquid crystal display device, an electroluminescence display device, a plasma display device, a field emission display device, and the like, but is not limited thereto.

Hereinafter, a method of producing a polyamideimide film of an embodiment will be illustrated.

As an example, the method of producing a polyamideimide film according to an embodiment may include:

(a) dissolving an aromatic diamine in an organic solvent and reacting the solution with an acid anhydride and an aromatic diacid dichloride to prepare a polyamic acid resin composition;

(b) imidizing the polyamic acid resin composition to prepare a polyamideimide resin;

(c) adding inorganic nanoparticles to a solution including the polyamideimide resin to prepare a polyamideimide resin mixture solution; and

(d) applying and drying the polyamideimide resin mixture solution to produce a polyamideimide film.

It is preferred to carry out the method of producing a polyamideimide film according to an embodiment using a reactor provided with an agitator, a nitrogen injection device, a dropping device, a temperature controller, and a cooler, though the method is not largely limited.

In the method of producing a polyamideimide film according to an embodiment, step (a) of preparing a polyamic acid resin composition may be, in an embodiment, polymerizing an aromatic diamine, an acid anhydride, and an aromatic diacid dichloride at the same time, or may be reacting an aromatic diamine with an aromatic diacid dichloride to prepare an oligomer having an amine end and then reacting the oligomer with an additional aromatic diamine and a dianhydride to prepare the resin composition, but the present disclosure is not necessarily limited thereto.

When the oligomer having an amine end is prepared and then is reacted with the additional aromatic diamine and a dianhydride, a block polyamideimide resin may be prepared, and the mechanical properties of the film may be further improved.

Here, the step of preparing an oligomer having an amine end may include reacting an aromatic diamine and an aromatic diacid dichloride in a reactor; and purifying and drying an obtained oligomer. In this case, the aromatic diamine may be added at a mole ratio of 1.01 to 2 with respect to the aromatic diacid dichloride, but the present disclosure is not necessarily limited thereto. In addition, the weight average molecular weight of the oligomer having an amine end may be, for example, 1,000 to 3,000 g/mol, but is not necessarily limited thereto.

In addition, the step of reacting the oligomer with an additional aromatic diamine and a dianhydride may be, in an embodiment, adding an organic solvent to a reactor, adding the oligomer, an aromatic diamine, and a dianhydride thereto, and performing polymerization, but is not necessarily limited thereto.

When the polyamic acid resin composition is prepared, reactivity of the aromatic diamine may be increased by adding the monomer to the organic solvent, not altogether, but in a stepwise manner and performing a reaction. In addition, it is preferred to firstly add the aromatic diamine to the organic solvent, and then perform sufficient dissolution.

Here, the organic solvent used may be any one or a mixture of two or more selected from dimethylacetamide (DMAc), N-methyl-2-pyrrolidone (NMP), dimethylformamide (DMF), dimethylformsulfoxide (DMSO), acetone, ethyl acetate, m-cresol, and the like. Specifically, dimethylacetamide (DMAc) may be used, but the present disclosure is not necessarily limited thereto.

It is preferred that in step (a), the polymerization is performed under an inert gas atmosphere, and as an example, polymerization may be performed while nitrogen or argon gas may be refluxed in the reactor. In addition, a reaction temperature range is from room temperature to 80° C., specifically 20 to 80° C., and a reaction time is 30 minutes to 24 hours, but the present disclosure is not necessarily limited thereto as long as the object of the present disclosure is achieved. Step (b) of imidization is imidizing the polyamic acid resin composition prepared in step (a) to obtain a polyamideimide resin, and a known imidization method, for example, a thermal imidization method, a chemical imidization method, and a combination of a thermal imidization method and a chemical imidization method may be applied, but the present disclosure is not necessarily limited thereto.

In the method of producing a polyamideimide film according to an embodiment, the chemical imidization may be performed by further including any one or two or more selected from an imidization catalysts and a dehydrating agent in a prepared solution including the polyamic acid resin composition, but the present disclosure is not necessarily limited thereto as long as the object of the present disclosure is achieved.

Here, the dehydrating agent may be any one or a mixture of two or more selected from acetic anhydride, phthalic anhydride, and maleic anhydride, and the imidization catalyst may be any one or a mixture of two or more selected from pyridine, isoquinoline, and β-quinoline, but the present disclosure is not necessarily limited thereto as long as the object of the present disclosure is achieved.

In step (c), the inorganic nanoparticles are added to the organic solvent for improving the dispersibility of the inorganic nanoparticles, and it is more preferred to add it in a state of an organic solution dispersed by means such as ultrasound. In addition, it is more preferred to add surface-treated inorganic nanoparticles of which the surface is modified, for improving dispersibility. When the inorganic nanoparticles in the form of a solid which is not dispersed in an organic solvent are directly added, it is difficult to uniformly disperse the inorganic nanoparticles in the polyamideimide film, and thus, it may be somewhat difficult to implement optical properties and mechanical properties to be derived in the present disclosure.

Here, the type of organic solvent is not largely limited, and as an example, may be any one or a mixture of two or more selected from dimethylacetamide (DMAc), N-methyl-2-pyrrolidone (NMP), dimethylformamide (DMF), dimethylformsulfoxide (DMSO), acetone, ethyl acetate, m-cresol, and the like. Specifically, dimethylacetamide (DMAc) may be used, but the present disclosure is not necessarily limited thereto.

Step (d) of applying a polyamideimide resin mixture solution may further include a heat treatment step after the application. The heat treatment step is casting the polyamideimide resin mixture solution on a support such as a glass substrate and performing a heat treatment to form a film. The heat treatment may be carried out in a stepwise manner, and specifically, may be carried out in a stepwise manner at 80 to 100° C. for 1 minute to 2 hours, at 100 to 200° C. for 1 minute to 2 hours, or at 250 to 300° C. for 1 minute to 2 hours, and more specifically, the stepwise heat treatment depending on each temperature range may be carried out for 30 minutes to 2 hours, but is not necessarily limited thereto as long as the object of the present disclosure is achieved. Here, the stepwise heat treatment may be performed by heating in a range of 1 to 20° C./min at each step moving. In addition, the heat treatment may be performed in a separate vacuum oven, but is not necessarily limited thereto as long as the object of the present disclosure is achieved.

As described above, the polyamideimide film produced by the production method has excellent effects of satisfying a total light transmittance of 90% or more as measured at 400 to 700 nm in accordance with the ASTM D1003 specification to significantly improve viewing properties, satisfying a low refractive index of less than 1.63 to significantly improve transparency, and satisfying all physical properties of a retardation in the thickness direction (Rₜₕ) of 3,500 nm or less at a thickness of 50 μm, a haze of 1.5% or less, and a yellow index of 2.5 or less as measured in accordance with the ASTM E313 specification to have significantly improved optical properties, while maintaining excellent mechanical, thermal, and electrical properties.

Hereinafter, the present disclosure will be described in more detail with reference to the Examples and Comparative Examples. However, the following Examples and Comparative Examples are only an example for describing the present disclosure in more detail, and do not limit the present disclosure in any way.

[Method of Measuring Physical Properties]

(1) Refractive Index

A refractive index was measured using a prism coupler (Metricon, 2010) at a temperature of 23° C. in a wavelength region of 543 nm, based on the films having a thickness of 50 μm produced in the examples and the comparative examples.

(2) Light Transmittance

A light transmittance was measured using a spectrophotometer (Nippon Denshoku, COH-400) in an entire wavelength region of 400 to 700 nm in accordance with the ASTM D1003 specification, based on the films having a thickness of 50 μm produced in the examples and the comparative examples.

(3) Retardation in the Thickness Direction (Rₜₕ)

A retardation in the thickness direction was measured at a wavelength of 550 nm using Axoscan (Axometrics), based on the films having a thickness of 50 μm produced in the examples and the comparative examples. A Rₜₕ value calculated on a software was measured, based on a retardation trend to a tilt angle (0-45°), with two axes including a slow axis and a fast axis of a sample being as axes of rotation.

(4) Modulus

A modulus was measured, using Instron UTM 3365, under the condition of pulling the films having a thickness of 50 μm, a length of 50 mm, and a width of 10 mm produced in the examples and the comparative examples at 25° C. at 50 mm/min.

(5) Haze

A haze was measured, using a spectrophotometer (Nippon Denshoku, COH-400) in accordance with the ASTM D1003 specification, based on the films having a thickness of 50 μm produced in the examples and the comparative examples.

(6) Yellow Index (YI)

A yellow index was measured using a spectrophotometer (Nippon Denshoku, COH-400) in accordance with the ASTM E313 specification, based on the films having a thickness of 50 μm produced in the examples and the comparative examples.

### Example 1

N,N-dimethylacetamide (DMAc) and 2,2′-bis(trifluoromethyl)-benzidine (TFMB) were added to a reactor under a nitrogen atmosphere, stirring was sufficiently performed, terephthaloyl dichloride (TPC) was added thereto, and stirring was performed for 6 hours to perform dissolution and reaction.

Thereafter, a reaction product obtained by using excessive methanol to perform precipitation and filtration was dried under vacuum at 50° C. for 6 hours or more to obtain an oligomer.

N,N-dimethylacetamide (DMAc), the oligomer, and additional 2,2′-bis(trifluoromethyl)-benzidine (TFMB) were added to the reactor again under a nitrogen atmosphere so that the aromatic diamine is 100 mol, cyclobutanetetracarboxylic dianhydride (CBDA) and 4,4′-hexafluoroisopropylidene diphthalic anhydride (6FDA) were sequentially added, and stirring was performed at 40° C. for 12 hours to perform dissolution and reaction to prepare a polyamic acid resin composition. Here, the molar ratio of each monomer add is TFMB:6FDA:CBDA:TPC=100:15:15:70, the solid content was adjusted to be 10 wt %, and a temperature of the reactor was maintained at 40° C.

Subsequently, each of pyridine and acetic anhydride was added sequentially to the solution at a mole ratio 2.5 times the total content of dianhydride, and stirring was performed at 60° C. for 12 hours to prepare a solution including a polyamideimide resin. The polyamideimide resin had a weight average molecular weight of 210,000 g/mol.

Silica particles which were dispersion treated in DMAc were added to the solution including the polyamideimide resin to obtain a polyamideimide resin mixture solution. At this time, the silica particles were added so that the content was 38 wt % in the solid content of the entire polyamideimide resin mixture after adding the silica particles, and the silica had an average diameter of 10 nm and a refractive index of 1.45.

The polyamideimide resin mixture solution was cast on a glass substrate using an applicator. Thereafter, first drying was performed in a drying oven at 90° C. for 30 minutes, a heat treatment was performed in a curing oven at 300° C. for 30 minutes under a N₂ condition, cooling to room temperature was performed, and a film formed on the glass substrate was separated from the substrate to obtain a polyamideimide film having a thickness of 50 μm.

The physical properties of the thus-obtained polyamideimide film are shown in the following Table 1.

### Example 2

A polyamideimide film having a thickness of 50 μm was obtained in the same manner as in Example 1, except that the silica particles were added so that their content was 44 wt % in the solid content of the polyamideimide resin mixture.

The physical properties of the thus-obtained polyamideimide film are shown in the following Table 1.

### Example 3

A polyamideimide film having a thickness of 50 μm was obtained in the same manner as in Example 1, except that the silica particles were added so that their content was 23 wt % in the solid content of the polyamideimide resin mixture.

The physical properties of the thus-obtained polyamideimide film are shown in the following Table 1.

### Example 4

A polyamideimide film having a thickness of 50 μm was obtained in the same manner as in Example 1, except that the silica particles had an average diameter of 35 nm.

The physical properties of the thus-obtained polyamideimide film are shown in the following Table 1.

### Example 5

A polyamideimide film having a thickness of 50 μm was obtained in the same manner as in Example 1, except that the silica particles were added so that their content was 52 wt % in the solid content of the polyamideimide resin mixture.

The physical properties of the thus-obtained polyamideimide film are shown in the following Table 1.

### Example 6

A polyamideimide film having a thickness of 50 μm was obtained in the same manner as in Example 1, except that the silica particles were added so that their content was 65 wt % in the solid content of the polyamideimide resin mixture.

The physical properties of the thus-obtained polyamideimide film are shown in the following Table 1.

### Comparative Example 1

N,N-dimethylacetamide (DMAc) and 2,2′-bis(trifluoromethyl)-benzidine (TFMB) were added to a reactor under a nitrogen atmosphere, stirring was sufficiently performed, terephthaloyl dichloride (TPC) was added thereto, and stirring was performed for 6 hours to perform dissolution and reaction.

Thereafter, a reaction product obtained by using excessive methanol to perform precipitation and filtration was dried under vacuum at 50° C. for 6 hours or more to obtain an oligomer.

N,N-dimethylacetamide (DMAc), the oligomer, and additional 2,2′-bis(trifluoromethyl)-benzidine (TFMB) were added to the reactor again under a nitrogen atmosphere so that the aromatic diamine is 100 mol, cyclobutanetetracarboxylic dianhydride (CBDA) and 4,4′-hexafluoroisopropylidene diphthalic anhydride (6FDA) were sequentially added, and stirring was performed at 40° C. for 12 hours to perform dissolution and reaction to prepare a polyamic acid resin composition. Here, the molar ratio of each monomer add is TFMB:6FDA:CBDA:TPC=100:15:15:70, the solid content was adjusted to be 10 wt %, and a temperature of the reactor was maintained at 40° C.

Subsequently, each of pyridine and acetic anhydride was added sequentially to the solution at a mole ratio 2.5 times the total content of dianhydride, and stirring was performed at 60° C. for 12 hours to prepare a solution composition including a polyamideimide resin. The polyamideimide resin had a weight average molecular weight of 210,000 g/mol.

The solution including a polyamideimide resin was cast on a glass substrate using an applicator. Thereafter, first drying was performed in a drying oven at 90° C. for 30 minutes, a heat treatment was performed in a curing oven at 300° C. for 30 minutes under a N₂ condition, cooling to room temperature was performed, and a film formed on the glass substrate was separated from the substrate to obtain a polyamideimide film having a thickness of 50 μm.

The physical properties of the thus-obtained polyamideimide film are shown in the following Table 1.

### Comparative Example 2

A polyamideimide film having a thickness of 50 μm was obtained in the same manner as in Example 1, except that the silica particles were added so that their content was 15 wt % in the solid content of the polyamideimide resin mixture.

The physical properties of the thus-obtained polyamideimide film are shown in the following Table 1.

### Comparative Example 3

A process was performed in the same manner as in Example 1, except that the silica particles were added so that their content was 75 wt % in the solid content of the polyamideimide resin mixture, and in this case, a film was not obtained.

### Comparative Example 4

A polyamideimide film having a thickness of 50 μm was obtained in the same manner as in Example 1, except that the silica particles had an average diameter of 62 nm.

The physical properties of the thus-obtained polyamideimide film are shown in the following Table 1.

### Comparative Example 5

A polyamideimide film having a thickness of 50 μm was obtained in the same manner as in Example 1, except that the silica particles had an average diameter of 90 nm.

The physical properties of the thus-obtained polyamideimide film are shown in the following Table 1.

### Comparative Example 6

A polyamideimide film having a thickness of 50 μm was obtained in the same manner as in Example 1, except that the silica particles had an average diameter of 90 nm and were added so that their content was 44 wt % in the solid content of the polyamideimide resin mixture.

The physical properties of the thus-obtained polyamideimide film are shown in the following Table 1.

TABLE 1

| | Content | | | | Retardation | | | |
|---|---|---|---|---|---|---|---|---|
| | ratio of | Inorganic | | | in the | | | |
| | inorganic | particle | | Total light | thickness | | | |
| | nanoparticles | size | Refractive | transmittance | direction | Modulus | Yellow | Haze |
| | (%) | (nm) | index | (%) | (nm) | (GPa) | index | (%) |
| Example 1 | 38 | 10 | 1.57 | 91.7 | 3,125 | 6.85 | 1.49 | 0.44 |
| Example 2 | 44 | 10 | 1.56 | 91.9 | 2,463 | 6.92 | 1.59 | 0.62 |
| Example 3 | 23 | 10 | 1.60 | 91.2 | 3,329 | 6.59 | 1.8 | 0.34 |
| Example 4 | 38 | 35 | 1.56 | 91.0 | 2,720 | 6.8 | 2.0 | 0.82 |
| Example 5 | 52 | 10 | 1.53 | 92.0 | 1,988 | 6.62 | 2.23 | 1.19 |
| Example 6 | 65 | 10 | 1.50 | 92.3 | 1,512 | 6.93 | 2.42 | 1.42 |
| Comparative | 0 | — | 1.63 | 89.6 | 4,798 | 6.05 | 2.31 | 0.37 |
| Example 1 | | | | | | | | |
| Comparative | 15 | 10 | 1.61 | 89.8 | 3,875 | 6.22 | 2.1 | 0.35 |
| Example 2 | | | | | | | | |
| Comparative | 75 | 10 | Film not obtainable | | | | | |
| Example 3 | | | | | | | | |
| Comparative | 38 | 62 | 1.55 | 87.26 | 2,612 | 6.94 | 7.21 | 5.47 |
| Example 4 | | | | | | | | |
| Comparative | 38 | 90 | 1.54 | 85.88 | 2,431 | 7.15 | 10.17 | 10.57 |
| Example 5 | | | | | | | | |
| Comparative | 44 | 90 | 1.52 | 83.97 | 1,920 | 7.51 | 15.16 | 15.19 |
| Example 6 | | | | | | | | |

As seen in Table 1, it was confirmed that the polyamideimide films of Examples 1 to 6, which included a polyamideimide resin derived from an aromatic diamine, an acid anhydride, and an aromatic diacid dichloride and inorganic nanoparticles, in which the inorganic nanoparticle satisfied the size and the content range defined in an embodiment, satisfied a total light transmittance of 90% or more as measured at 400 to 700 nm in accordance with the ASTM D1003 specification, satisfied a low refractive index of less than 1.63, and satisfied all physical properties of a retardation in the thickness direction (Rₜₕ) of 3,500 nm or less at a thickness of 50 μm, a haze of 1.5% or less, and a yellow index of 2.5 or less as measured in accordance with the ASTM E313 specification to have significantly excellent optical properties.

In addition, a modulus (Gpa) was also not greatly deteriorated in all examples, and thus, it was confirmed that the mechanical properties were also excellent.

In particular, in the case of the polyamideimide film of Comparative Example 1 including no inorganic nanoparticles showed a low value of a total light transmittance of less than 90% as measured at 400 to 700 nm in accordance with the ASTM D1003 specification, had a higher refractive index than the examples, and showed a high value of a retardation in the thickness direction (Rₜₕ) of 3500 nm at a thickness of 50 μm, and thus, it was confirmed that the transparency and visibility of the film were greatly deteriorated, and it was confirmed that optical properties such as a yellow index was lowered and a modulus (Gpa) showing mechanical properties was significantly lowered.

In addition, the polyamideimide film of Comparative Example 2 in which the content of the inorganic nanoparticles lacked the content defined in an embodiment also showed a low value of a total light transmittance of less than 90% as measured at 400 to 700 nm in accordance with the ASTM D1003 specification, and a high value of a retardation in the thickness direction (Rₜₕ) of more than 3500 nm at a thickness of 50 μm, and thus, it was confirmed that transparency and visibility were lowered.

In addition, in Comparative Example 3 in which the content of the inorganic nanoparticles exceeded the content defined in an embodiment, it was confirmed that the polyamideimide film itself was not formed.

Besides, it was confirmed that the polyamideimide film of Comparative Examples 5 to 7 in which the size of the inorganic nanoparticles exceeded the size defined in an embodiment also showed a low value of a total light transmittance of less than 90% as measured at 400 to 700 nm in accordance with the ASTM D1003 specification, and even a yellow index of 7.0 or more and a haze of 5.0% or more, so that the optical properties were very significantly deteriorated.

Accordingly, by providing a polyamideimide film including a certain content of inorganic nanoparticles by an implementation, the film may satisfy a total light transmittance of 90% or more as measured at 400 to 700 nm in accordance with the ASTM D1003 specification to significantly improve viewing properties, may satisfy a low refractive index of less than 1.63 to significantly improve transparency, and may satisfy all physical properties of a retardation in the thickness direction (Rₜₕ) of 3,500 nm or less at a thickness of 50 μm, a haze of 1.5% or less, and a yellow index of 2.5 or less as measured in accordance with the ASTM E313 specification to have significantly improved optical properties such as visibility, while maintaining excellent mechanical, thermal, and electrical properties.

Hereinabove, although the polyamideimide film and the image display device including the same have been described in the present disclosure by specific matters and limited examples, the exemplary embodiments have been provided only for assisting in the entire understanding of the present disclosure, and the present disclosure is not limited to the above exemplary embodiments. Various modifications and changes may be made by those skilled in the art to which the present disclosure pertains from this description.

Therefore, the spirit of the present disclosure should not be limited to the above-described exemplary embodiments, and the following claims as well as all modified equally or equivalently to the claims are intended to fall within the scope and spirit of the disclosure.

1. A polyamideimide film comprising: a polyamideimide resin derived from an aromatic diamine, an acid anhydride, and an aromatic diacid dichloride; and inorganic nanoparticles;
wherein a content of the inorganic nanoparticles is 20 to 65 wt % of the polyamideimide film, and
a total light transmittance of the polyamideimide film is 90% or more as measured at 400 to 700 nm in accordance with the ASTM D1003 specification.

2. The polyamideimide film of claim 1, wherein the inorganic nanoparticles have an average diameter of 50 nm or less.

3. The polyamideimide film of claim 1, wherein the inorganic nanoparticles have an average diameter of 5 to 20 nm.

4. The polyamideimide film of claim 1, wherein a content of the inorganic nanoparticles is 20 to 50 wt % of the polyamideimide film.

5. The polyamideimide film of claim 1, wherein the inorganic nanoparticles are any one or a mixture of two or more selected from silica, zirconium oxide, titanium oxide, zinc oxide, zinc sulfide, chromium oxide, and barium titanate.

6. The polyamideimide film of claim 1, wherein the inorganic nanoparticles are surface-treated for improving dispersibility in an organic solvent.

7. The polyamideimide film of claim 1, wherein the aromatic diamine is any one or a mixture of two or more selected from N,N′-[2,2′-bis(trifluoromethyl)-[1,1′-biphenyl]-4,4′-diyl] bis[4-aminobenzamide] (AB-TFMB), 2,2′-bis(trifluoromethyl)-benzidine (TFMB), 4,4′-diaminobenzanilide (DABA), 1,4-bis(4-amino-2-trifluoromethylphenoxy)benzene (6FAPB), and 2,2′-bis(trifluoromethyl)-4,4′-diaminodiphenylether (6FODA).

8. The polyamideimide film of claim 1, wherein the aromatic diacid dichloride is any one or a mixture of two or more selected from terephthaloyl dichloride, isophthaloyl dichloride, 1,1′-biphenyl-4,4′-dicarbonyl dichloride, 1,4-naphthalene dicarboxylic dichloride, 2,6-naphthalene dicarboxylic dichloride, and 1,5-naphthalene dicarboxylic dichloride.

9. The polyamideimide film of claim 1, wherein a content of the aromatic diacid dichloride is more than 50 mol % with respect to both of the acid anhydride and the aromatic diacid dichloride.

10. The polyamideimide film of claim 1, wherein the acid anhydride includes an aromatic dianhydride and a cycloaliphatic dianhydride.

11. The polyamideimide film of claim 10, wherein the aromatic dianhydride is 4,4′-hexafluoroisopropylidene diphthalic anhydride, and the cycloaliphatic dianhydride is cyclobutanetetracarboxylic dianhydride.

12. The polyamideimide film of claim 10, wherein the cycloaliphatic dianhydride is any one or a mixture of two or more selected from 1,2,3,4-cyclobutanetetracarboxylic dianhydride (CBDA), 5-(2,5-dioxotetrahydrofuryl)-3-methylcyclohexene-1,2-dicarboxylic dianhydride (DOCDA), bicyclooxtene-2,3,5,6-tetracarboxylic dianhydride (BODA), 1,2,3,4-cyclopentanetetracarboxylic dianhydride (CPDA), 1,2,4,5-cyclohexanetetracarboxylic dianhydride (CHDA), 1,2,4-tricarboxy-3-methylcarboxycyclopentane dianhydride, and 1,2,3,4-tetracarboxycyclopentane dianhydride.

13. The polyamideimide film of claim 1, wherein the polyamideimide film has a refractive index of less than 1.63 and a retardation in the thickness direction (Rₜₕ) of 3,500 nm or less at a thickness of 50 μm.

14. The polyamideimide film of claim 1, wherein the polyamideimide film has a haze of 1.5% or less as measured in accordance with the ASTM D1003 specification and a yellow index of 2.5 or less as measured in accordance with the ASTM E313 specification.

15. The polyamideimide film of claim 1, wherein the polyamideimide film has a haze of 0.7% or less as measured in accordance with the ASTM D1003 specification.

16. The polyamideimide film of claim 1, wherein the polyamideimide film has a modulus of 5.0 GPa or more as measured at an extension speed of 50 mm/min using Instron UTM 3365.

17. An image display device comprising the polyamideimide film according to claim 1.
